(19) United States
(12) Patent Application Publication
(10) Pub. No.: US 2019/0308725 A1
(43) Pub. Date: Oct. 10, 2019

(54) RAPIDLY RECONFIGURABLE PALLETIZED MISSION EQUIPMENT MOUNTING SYSTEMS AND METHODS

(71) Applicant: Bell Helicopter Textron Inc., Fort Worth, TX (US)

(72) Inventors: Jimmy Dale Sherman, North Richland Hills, TX (US); Mark Gibson Tynes, North Richland Hills, TX (US); Eric John Robertson, Fort Worth, TX (US); Carl Alan May, Mansfield, TX (US); Randall Thompson Willnow, Burleson, TX (US)

(73) Assignee: Bell Helicopter Textron Inc., Fort Worth, TX (US)

(21) Appl. No.: 15/946,598

(22) Filed: Apr. 5, 2018

(51) Int. Cl. B64D 9/00

(52) U.S. Cl. CPC B64D 9/003

(57) ABSTRACT

Rapidly reconfigurable palletized mission equipment mounting systems and methods employ a plurality of tracks or rails installed in an aircraft fuselage. Mission equipment is secured on a pallet. The pallet is a rapidly reconfigurable mission equipment mounting pallet body defining a plurality of orifices sized to accept releasable anchor hardware, positioned to align with the tracks or rails installed in the aircraft and readily releasable anchors disposed in the orifices and configured to rapidly mount to, and rapidly dismount from, the tracks or rails. The pallet with the mission package(s) secured thereto is transferred into the aircraft and mounted the pallet in the aircraft on the tracks or rails, via the readily releasable anchors, for rapidly dismounting from the tracks or rails.

### STATEMENT REGARDING FEDERALLY SPONSORED RESEARCH OR DEVELOPMENT

This invention was made with government support under N00019-15-G-0026 awarded by the Department of Defense. The government has certain rights in the invention.

### TECHNICAL FIELD

The present disclosure relates generally to aircraft, more particularly to mission equipment installation, and specifically to rapidly reconfigurable installation of mission (avionics) packages for aircraft using palletized mission mounting systems.

### BACKGROUND

Secure mounting provision for aircraft mission equipment (e.g. avionics, cargo, payload, fuel, weapons, etc.) usually calls for permanently affixing the mission equipment in the aircraft's interior. For example, mounting racks for mission equipment typically permanently installed and become part of the fixed aircraft configuration. Similarly, avionics, or the like, are typically hardwired into aircraft, using permanent wiring to connect the avionics.

Revisions of mission equipment packages require rework of installation hardware and reconfiguration of the aircraft through an extensive aircraft modification process. Changes to mission configuration would normally be carried out at an aircraft depot level service center. Once modified, that aircraft configuration is again set and does not change until the next major modification. This makes reconfiguration a lengthy and labor-intensive process.

Further, consistent with the above, maintenance and/or repair of mission equipment must normally be performed on the aircraft, thereby such maintenance and/or repair of mission equipment will be time consuming. Further, since the maintenance and/or repair of mission equipment must normally be performed on-aircraft, aircraft readiness will be reduced, since the aircraft will be out of commission until the maintenance and/or repair is completed.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is directed to systems and methods which provide rapidly reconfigurable palletized mission equipment mounting, employing a plurality of tracks or rails installed in an aircraft fuselage. These tracks or rails may be installed in on any flat surface, vertical or horizontal, such as a deck of vertical bulkhead and/or an interior horizontal bulkhead or floor of a fuselage of the aircraft. In operation, at least one mission package can be secured on a mission equipment mounting pallet, outside the aircraft. The pallet, with the mission package(s) secured thereto, is transferred into the aircraft and mounted, via the readily releasable anchors, in the aircraft on the tracks or rails, enabling later rapid dismount from the tracks or rails. Any needed electrical harnesses of the aircraft may then be connected to avionics mission package(s), or the like.

In accordance with other embodiments of the present systems and methods, the pallet may be mounted onto the tracks or rails inside the aircraft and the mission equipment mounted on the installed pallet.

As noted, a mission equipment mounting pallet mounts at least one mission package. In accordance with various embodiments of the present systems and methods, the mission equipment mounting pallet is a rapidly reconfigurable mission equipment mounting pallet body defining a plurality of orifices sized to accept releasable anchor hardware and positioned to align with the tracks or rails installed in the aircraft. The pallet body may be a lightweight bonded panel, such as a lightweight honeycomb core bonded panel, or the like. The orifices may each be pallet through-holes that extend generally perpendicular to a mission equipment mounting surface of the pallet body and may be sized to accept and retain the readily releasable anchors.

In some implementations, a center of gravity of the aircraft may be adjusted using the present rapidly reconfigurable mission equipment mounting systems and methods. For example, the readily releasable anchors securing a mission equipment mounting pallet mounting (a) mission package(s) may be loosened. The pallet may then be moved along the rails, and resecured, via the readily releasable anchors, thereby repositioning the aircraft center of gravity.

Implementation of the present systems and methods for rapidly reconfigurable mission equipment mounting may facilitate swapping-out currently mounted mission package(s) with one or more different mission packages. In such an implementation, the pallet mounting current mission package(s) is dismounted from the tracks or rails by releasing the readily releasable anchors. The pallet mounting current mission package(s) is removed from the aircraft. A pallet mounting (a) different mission package(s) is transferred into the aircraft and mounted, via the readily releasable anchors, in the aircraft on the tracks or rails, enabling subsequent rapid dismount from the tracks or rails.

Implementation of the present systems and methods for rapidly reconfigurable mission equipment mounting may also expedite maintenance of mission packages on the aircraft. For example, a pallet mounting (a) mission package(s) to be repaired or maintained is dismounted from the tracks or rails, by releasing the anchors and removed from the aircraft. A pallet mounting (a) new, repaired or maintained mission package(s) is transferred into the aircraft, and mounted, via the readily releasable anchors, in the aircraft on the tracks or rails, enabling later rapid dismount from the tracks or rails.

Also, the present systems and methods for rapidly reconfigurable mission equipment mounting may also expedite replacement or maintenance of mission packages on the aircraft by enabling dismounting of current mission packages from the pallet mounting the current mission packages. The dismounted current mission packages may then be removed from the aircraft. Replacement mission package(s) may then be transferred into the aircraft and mounted on the pallet, in the aircraft.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Having thus described the invention in general terms, reference will now be made to the accompanying drawings, which are not necessarily drawn to scale and which are incorporated in and form part of the specification and in which like numerals designate like parts, illustrate embodiments of the present invention and together with the description, serve to explain the principles of the invention. In the drawings:

FIG. 1 is a flowchart of a rapidly reconfigurable palletized mission equipment mounting example method, in accordance with at least one embodiment;

FIG. 2 is a flowchart of a rapidly reconfigurable mission equipment mounting example method, in accordance with at least one embodiment;

FIG. 3 is a diagrammatic perspective illustration showing prior art aircraft equipment track and fitting;

FIG. 4 is a diagrammatic perspective illustration of the prior art equipment track fitting shown in FIG. 1;

FIG. 5 is another diagrammatic perspective illustration of the prior art equipment track fitting shown in FIGS. 1 and 2;

FIG. 6 is a diagrammatic perspective illustration of an example rapidly reconfigurable palletized mission equipment mounting system, according to at least one embodiment;

FIG. 7 is a diagrammatic perspective illustration of an example rapidly reconfigurable mission equipment mounting pallet deployed in conjunction with aircraft equipment track, according to at least one embodiment;

FIG. 8 is a diagrammatic, partially exploded, partially fragmented, cross-sectional perspective illustration of the example rapidly reconfigurable mission equipment mounting pallet of FIGS. 6 and 7 deployed in conjunction with the aircraft equipment track, according to at least one embodiment.

While this specification provides several embodiments and illustrative drawings, a person of ordinary skill in the art will recognize that the present specification is not limited only to the embodiments or drawings described. It should be understood that the drawings and detailed description are not intended to limit the specification to the particular form disclosed, but, on the contrary, the intention is to cover all modifications, equivalents and alternatives falling within the spirit and scope of the claims. As used herein, the word “may” is meant to convey a permissive sense (i.e., meaning “having the potential to”), rather than a mandatory sense (i.e., meaning “must”). Similarly, the words “include,” “including,” and “includes” mean “including, but not limited to.”

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

The present systems and methods are generally directed to aircraft, more particularly to mission equipment installation, and specifically to rapidly reconfigurable installation of mission packages for aircraft using palletized mission mounting systems and methods.

The present systems and methods are intended to provide a secure mounting provision for aircraft mission equipment (e.g. avionics, cargo, payload, fuel, weapons, passenger accommodations, etc.) that can be easily and quickly reconfigured with minimal tools, time, and manpower. Various embodiments of the present systems and methods incorporate a mounting shelf or rack that will act as a pallet for mission equipment. This shelf or rack is attached to the aircraft interior through the use of a rail or track system with standardized rail and anchor spacing. Some embodiments of the present systems and methods may use aircraft industry standard seat track rails. In accordance with such embodiments, these track rails may be permanently installed in the aircraft with standard fastener hardware. The shelf or rack may be loaded with the mission equipment outside of the aircraft to constitute a palletized mission rack that may be inserted in the aircraft and attached to the permanently installed tracks with standardized track anchor hardware.

In accordance with other embodiments of the present systems and methods, the pallet may be mounted onto the tracks or rails inside the aircraft, without any equipment mounted on the pallet. Then the mission equipment may be transferred into the aircraft and mounted on the installed pallet. This may be useful for heavy or cumbersome equipment, including equipment that, when mounted on the pallet, could not be maneuvered into the aircraft.

Palletizing the mission equipment simplifies multiple issues. The present systems and methods facilitate easy removal of the palletized mission rack, and the mission equipment deployed thereon, allowing work on avionics, or the like, to be performed “on the bench” instead of inside the aircraft. Palletizing in accordance with embodiments of the present systems and methods enables quick switching (i.e. swapping) from one mission equipment package to another, and/or supplementing of a current mission equipment package. Hence, under embodiments of the present systems and methods, speed and ease of removal and installation of mission equipment packages allows for quick aircraft mission package swaps to meet changing mission requirements. Similarly, palletizing, in accordance with the present systems and methods allows for multiple unrelated mission packages to be installed with common aircraft mounting features either individually or in parallel.

Additionally, palletizing, in accordance with the present systems and methods facilitates repositioning of the mission equipment to assure proper aircraft balance and optimization of the center of gravity. Such as/even when new equipment is deployed in the aircraft, which may also be installed using the present rapidly reconfigurable mounting system for palletized mission equipment.

Standard track hardware, readily available from aerospace suppliers, may be employed in various embodiments of the present systems and methods, which may result in reduced costs. However, in accordance with embodiments of the present systems and methods, palletized mission package kit could be purchased as a complete assembly from a supplier allowing it to be fabricated remotely, shipped to the customer, and stored until required for deployment. Such a mission package pallet may be interchangeable between aircraft configured with the same track mounting hardware. In accordance with such embodiments, multiple preconfigured mission pallets could be kept in inventory for rapid aircraft reconfiguration.

Use of the present rapidly reconfigurable mounting systems and methods for palletized mission equipment may facilitate maintenance of mission equipment since such maintenance may be performed by swapping-out the pallet containing malfunctioning equipment and/or equipment otherwise requiring maintenance with another pallet with a functional set of mission equipment thereby allowing the aircraft to return immediately to flight while diagnostic work and maintenance would be performed on the ground on the removed equipment.

By installing rails/tracks in the aircraft in accordance with embodiments of the present systems and methods, the mission package can be palletized for easy maintenance, removal, installation, repositioning, and swapping. For instance, avionics boxes can be hard mounted to a lightweight bonded panel so that it becomes a complete avionics subassembly. This subassembly may be mounted to the panel on a workbench instead of inside the aircraft. This pallet subassembly could then be carried to the aircraft and attached with standard anchor hardware to the permanently installed tracks/rails. Pallets employed in accordance with embodiments of the present systems and methods can vary widely in concept and configuration depending on the desired mission. One example might be a flat bonded honeycomb core panel that would accept potted insert for attaching equipment racks, cargo, etc. This panel has features that accept industry standard anchor hardware and configured to align with the tracks/rails installed in the aircraft. Once configured, the pallet would be carried to the aircraft and attached with the quick release anchors. Any final installation operations could then be quickly performed such as connecting electrical harnesses, grounding cables, fuel connections, loading miscellaneous cargo, etc.

Thus, in accordance with embodiments of the present systems and methods, rapidly reconfigurable palletized mission equipment mounting systems and methods employ a plurality of tracks or rails installed in or on any flat surface in the aircraft fuselage. Mission equipment is secured on a pallet, which may in accordance with various embodiments be a rapidly reconfigurable mission equipment mounting pallet body defining a plurality of orifices sized to accept releasable anchor hardware, positioned to align with the tracks or rails installed in the aircraft. Readily releasable anchors disposed in the orifices are configured to rapidly mount to, and rapidly dismount from, the tracks or rails. The pallet with the mission package(s) secured thereto is transferred into the aircraft and mounted the pallet in the aircraft on the tracks or rails, via the readily releasable anchors, for rapidly dismounting from the tracks or rails. In alternative embodiments the pallet may first be installed on the track or rails inside the aircraft, then the mission package(s) may be transferred into the aircraft and mounted on the installed pallet.

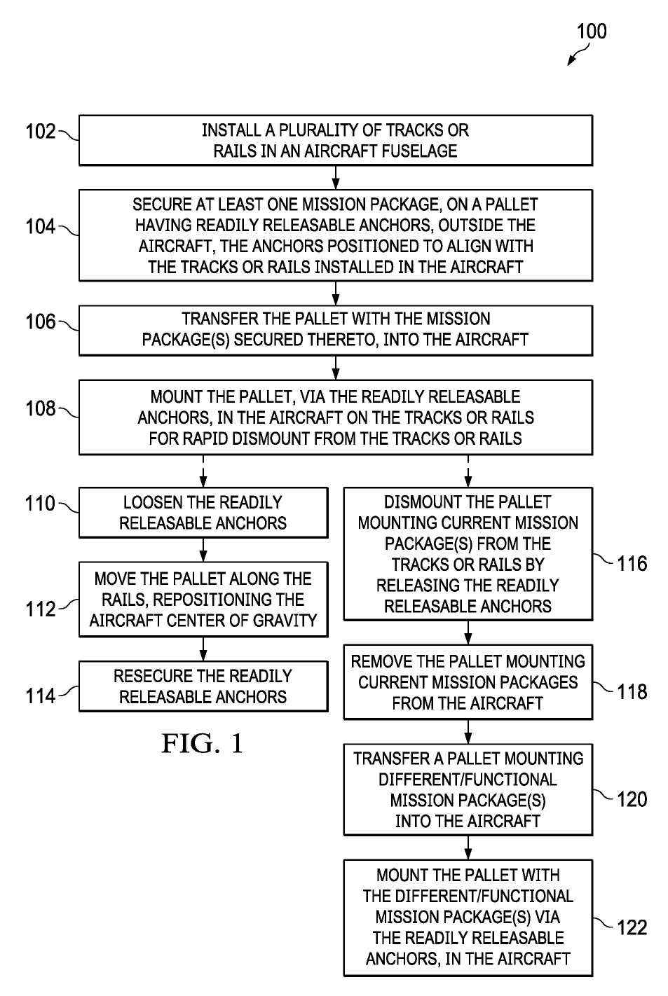

FIG. 1 is a flowchart of rapidly reconfigurable palletized mission equipment mounting example process 100, in accordance with at least one embodiment of the present systems and methods. Therein, a plurality of aircraft industry standard tracks (equipment tracks) are installed inside an aircraft fuselage at 102. At least one avionics box is affixed on a body of a pallet at 104. This may be carried out outside the aircraft, such as on a work bench, or the like, rather than in the cramped confines of the aircraft, in some implementations of the present systems and methods. This may be of particular advantage when dealing with avionics or other electronics, since grounding and/or electrical isolation of circuitry may be better accomplished in a more controlled-environment, such as a workbench.

As described below, the pallet may have a plurality of orifices (i.e. through-holes) accepting aircraft industry standard readily releasable anchors. These orifices, in accordance with the present systems and methods, extend generally perpendicular to a face (i.e. a mission equipment mounting surface) of the pallet, as pallet through-holes sized to accept and retain the aircraft industry standard readily releasable anchors. These anchors (and hence the orifices or cavities in which they are deployed) are positioned to align with the equipment tracks mounted in the aircraft. In accordance with embodiments of the present systems and methods the aircraft industry standard readily releasable anchors may be potted into the pallet body through-holes, as also described below.

At 106 the pallet is transferred to the aircraft and installed at 108, via the aircraft industry standard readily releasable anchors, in the aircraft on the equipment tracks for quick dismount from the equipment tracks. Whereupon, electrical harnesses of the aircraft are connected to the avionics boxes, if required. Dummy connector ends may be employed on one or both of ends of electrical harnesses of the aircraft and the avionics boxes. Alternatively, or additionally, wireless connectivity may be used to connect the avionics boxes and the aircraft's incorporated avionics, or the like.

In accordance with embodiments of the present rapidly reconfigurable mission equipment mounting systems and methods, the equipment tracks may be installed in or on any flat surface, vertical or horizontal, such as a deck of vertical bulkhead and/or an interior horizontal bulkhead or floor of a fuselage of the aircraft, at 102. Thereby, the pallet may be installed on the equipment tracks, via the aircraft industry standard readily releasable anchors to the deck inside the aircraft at 108. Alternatively, or additionally, space permitting within the aircraft fuselage, the equipment tracks may be installed on a vertical bulkhead of the aircraft fuselage at 102 and the pallet is mounted at 108, via the aircraft industry standard readily releasable anchors to the vertical bulkhead, inside the aircraft. In further embodiments, the equipment tracks may alternatively, or additionally, space permitting within the aircraft fuselage, be installed on any vertical bulkhead (e.g. ceiling) of the aircraft, such that the pallet body is mounted via the aircraft industry standard readily releasable anchors to the ceiling/interior bulkhead inside the aircraft.

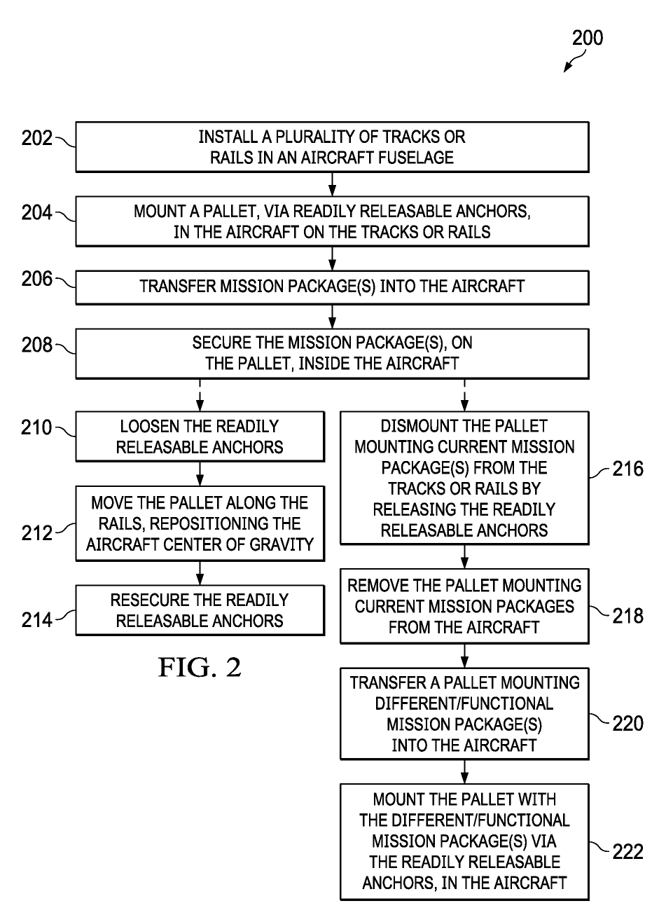

FIG. 2 is a flowchart of another rapidly reconfigurable mission equipment mounting example method 200, in accordance with at least one embodiment. Therein a plurality of aircraft industry standard tracks (equipment tracks) are installed inside an aircraft fuselage at 202. In accordance with embodiments of the present rapidly reconfigurable mission equipment mounting systems and methods, the equipment tracks may be installed in or on any flat surface, vertical or horizontal, such as a deck of vertical bulkhead and/or an interior horizontal bulkhead or floor of a fuselage of the aircraft, at 202.

At 204, the pallet may be installed on the equipment tracks, via aircraft industry standard readily releasable anchors, to the deck inside the aircraft. Alternatively, or additionally, if the equipment tracks are installed on a vertical bulkhead of the aircraft fuselage at 202, the pallet is mounted at 204, via the aircraft industry standard readily releasable anchors to the vertical bulkhead, inside the aircraft. In further embodiments, if the equipment tracks are installed on another horizontal bulkhead (e.g. ceiling) of the aircraft, the pallet body may be mounted via the aircraft industry standard readily releasable anchors to the ceiling/interior bulkhead inside the aircraft, at 204. At 206 at least one mission package is transferred into the aircraft, and secured on the pallet, inside the aircraft, at 208.

In accordance with embodiments of the present rapidly reconfigurable mission equipment mounting systems and methods a center of gravity of the aircraft may be adjusted. For example, the releasable anchors may be loosened (e.g. without entirely removing related fasteners), at 110 or 210. The pallet may then be moved along the rails at 112 or 212, changing the aircraft center of gravity. Then at 114 or 214 the releasable anchors may be resecured (i.e. fasteners retightened) to maintain the new center of gravity for the aircraft. As discussed further below, such embodiments may additionally, or alternatively, make use of motorized anchor hardware components, which may be used to shift the aircraft's center of gravity (CG), in real time.

Further, in accordance with embodiments of the present rapidly reconfigurable mission equipment mounting systems and methods may facilitate rapid “swapping-out” of one or more mission packages with one or more different mission packages. In accordance with such an implementation the pallet mounting current mission packages may first be dismounted from the tracks or rails by releasing the anchors at 116 or 216. Then, at 118 or 218, the pallet mounting the current mission packages is removed from the aircraft. Thereafter, a pallet mounting the new/different mission package(s) is transferred into the aircraft at 120 or 220, and the pallet mounting this/these new/different mission package(s) is mounted, via the releasable anchors, in the aircraft on the tracks or rails at 122 or 222, enabling future rapid dismount from the tracks or rails, such as for a subsequent mission package swap. As a result, the aircraft can be used for a different type of mission. Hence the present systems and methods enhance the possible missions profile of the aircraft, without major modifications.

Additionally, embodiments of the present rapidly reconfigurable mission equipment mounting systems and methods systems and methods may facilitate efficiently maintaining (servicing) mission packages on the aircraft, wherein the pallet mounting one or more (current) mission packages to be repaired or maintained is dismounted from the tracks or rails, at 116 or 216, by releasing the anchors, for removing the pallet mounting the e (current) mission package(s) to be repaired or maintained from the aircraft, at 118 or 218. Thereafter, a pallet mounting one or more functional (i.e. new, repaired or maintained) mission packages may be transferred into the aircraft, at 120 or at 220, and the pallet mounting the new, repaired or maintained (functional) mission package(s), may be mounted, via the releasable anchors, in the aircraft on the tracks or rails at, 122 or 222. This allows the aircraft to return to flight expeditiously, while diagnostic work and maintenance on the removed mission package(s) is performed on the ground.

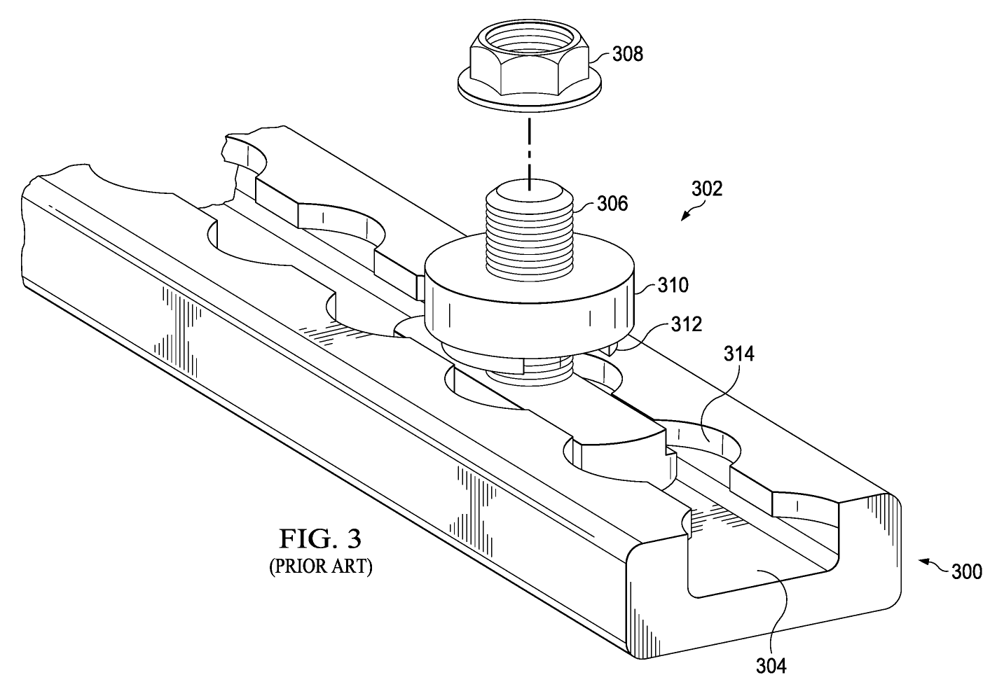

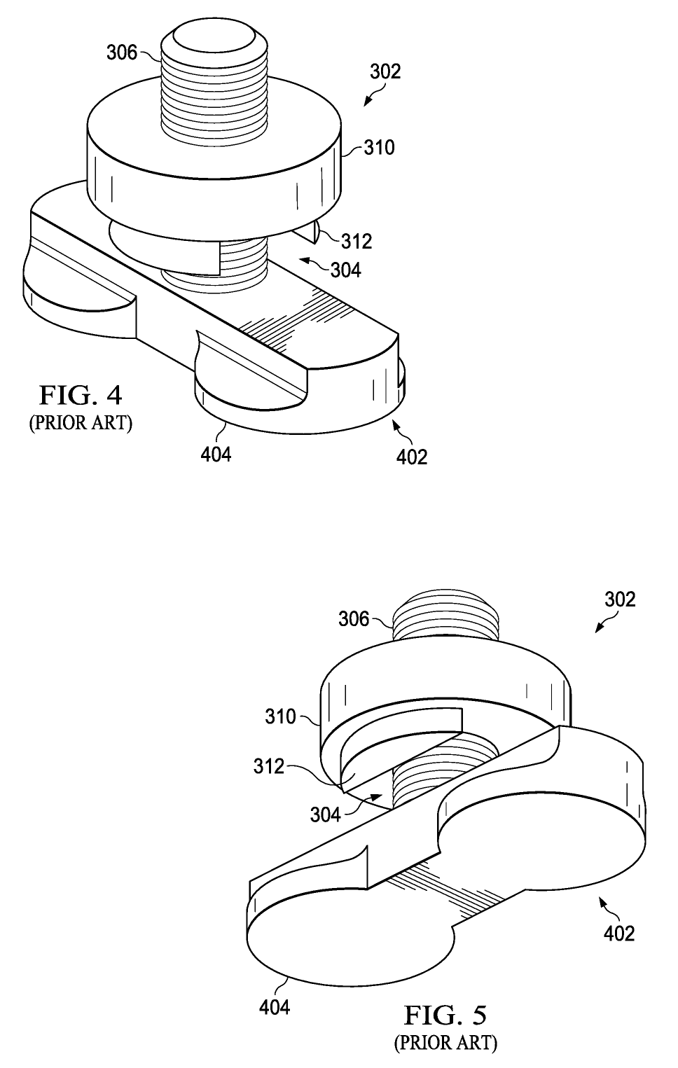

FIG. 3 is a diagrammatic perspective illustration showing prior art aircraft equipment track 300 and fitting 302. FIG. 4 is a diagrammatic perspective illustration of prior art equipment track fitting 302 shown in FIG. 3, while FIG. 5 is another diagrammatic perspective illustration of prior art equipment track fitting 302 shown in FIGS. 3 and 4. Equipment track 300, typically referred to as “L-track” or “ltrack.” (This name originates from use of this type of track in the airline industry.) is installed on, or in, the deck of an aircraft. Seats attach to the track, via fittings 302 rather than directly to the deck of the aircraft. These aircraft seat tracks allow for secure attachment of the seats, but with the option of moving or removing the seats as needed by moving the seats along the tracks or removing them from the track. L-track is typically made from aluminum such as a 6351 or 7075-T6 aluminum alloy, or the like. Aircraft L-track may have pre-drilled holes that are countersunk. L-track is typically low profile, but may also be installed in a recessed configuration, such as in a channel defined in the aircraft deck. Fitting 302 is typically comprised of stud 304 having base flange portions 402 (best seen in FIGS. 4 and 3) and (threaded) shaft portion 306 receiving fastener (nut) 308. Retainer 310 is shaped to be secured between fastener(nut) 308 and flange 402 of stud 304. A seat frame (e.g. a seat frame base hole) may be secured to stud 304, on (threaded) shaft 306, between fastener(nut) 308 and retainer 310. Tightening of fastener (nut) 308 pushes retainer indexing tab 312 of retainer 310 into track notch 314, while drawing fitting flange projection 404 against the track to retain the seat in place, along track 300.

Embodiments of the present systems and methods are described below with respect to deploying avionics boxes, or the like on a pallet. However, as one of skill in the art will appreciate, any number of mission packages may be deployed on, or in place of, the pallets employed in the present systems and methods, such as, power distribution equipment, weapons, ammunition for aircraft or palletized weapons, supplies, netted cargo, cargo boxes; fuel cells (for the aircraft); sensors, seats (mounted on the pallet and disposed in configurations deferring from typical, such as mounted perpendicular to the equipment tracks, etc.

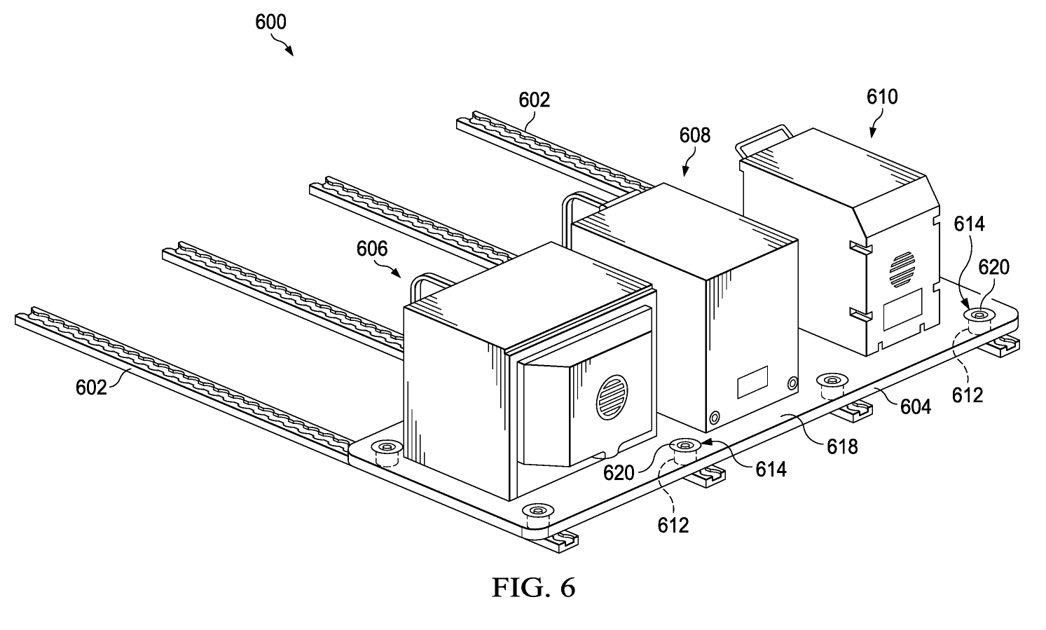

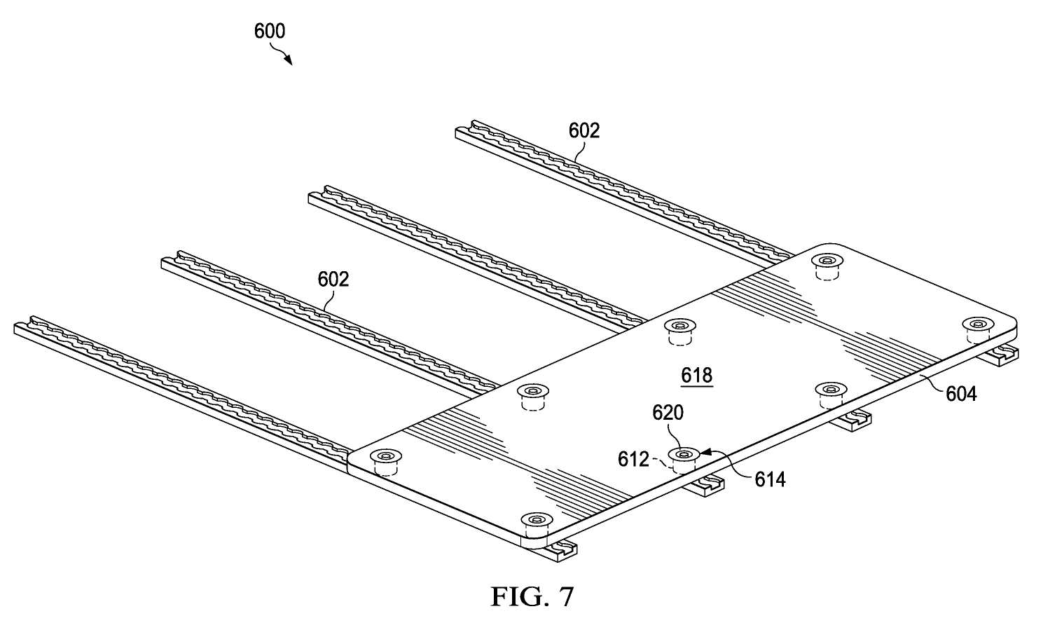

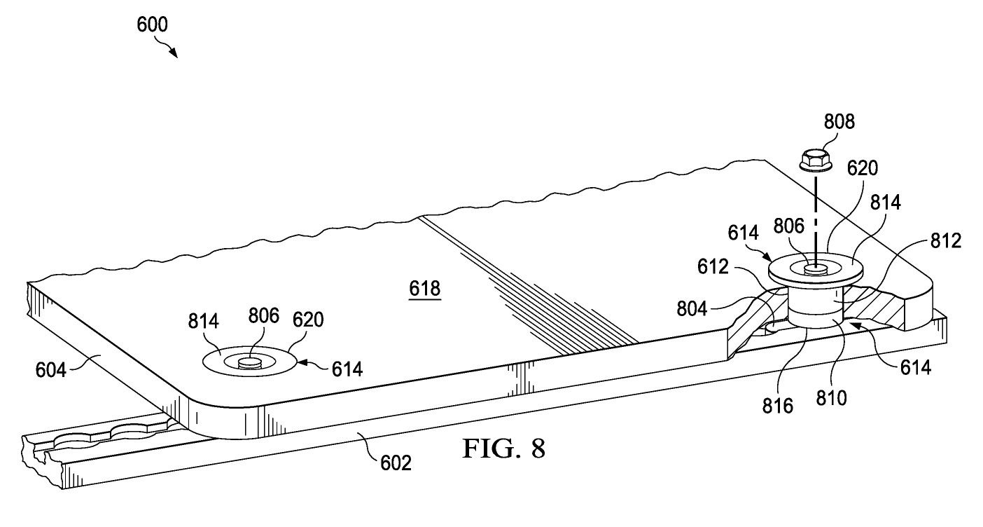

FIG. 6 is a diagrammatic perspective illustration of example rapidly reconfigurable palletized mission equipment mounting system 600, according to at least one embodiment of the present systems and methods. Therein, a plurality of aircraft industry standard tracks (equipment tracks 602) are installed inside (within) an aircraft fuselage (see 102 and 202 above). In accordance with embodiments of the present systems and methods pallet 604 mounts at least one avionics box 606, 608 and/or 610 (see 104 and 208, above). FIG. 7 is a diagrammatic perspective illustration of example low-profile rapidly reconfigurable mission equipment mounting pallet 604 deployed in conjunction with aircraft equipment track 602, according to at least one embodiment (such as at 204, above), while FIG. 8 diagrammatically illustrates, as a partially fragmented (i.e. partial cross-section) perspective view, example rapidly reconfigurable mission equipment mounting pallet 604 of FIGS. 6 and 7 deployed in conjunction with aircraft equipment track 602, according to at least one embodiment.

Equipment tracks 602 may be installed on any flat available surface, horizontal or vertical (such as discussed above with respect to 102 and 202). For example, as generally illustrated in FIGS. 6 through 8, equipment tracks 602 may be installed on, or recessed into the deck (i.e. floor) of a fuselage of the aircraft in which example rapidly reconfigurable palletized mission equipment mounting system 600 is to be deployed. Alternatively, or additionally, equipment tracks 602 may be installed on, or recessed into, a (vertical) bulkhead (i.e. wall or side) of the aircraft fuselage in which example rapidly reconfigurable palletized mission equipment mounting system 600 is to be deployed. As a further alternative or addition, equipment tracks 602 may be installed on, or recessed into any (other) interior horizontal bulkhead (e.g. ceiling) of the aircraft fuselage in which example rapidly reconfigurable palletized mission equipment mounting system 600 is to be deployed.

The body of pallet 604 may be comprised of a lightweight (aluminum honeycomb core) bonded panel, or the like. Likewise, pallet 604 may, in accordance with various embodiments of the present systems and methods, be a structural panel of any appropriate composition, such as, by way of example, machined aluminum, sheet metal (galvanized steel, aluminum, etc.), composite (such as carbon fiber), fiberglass (honeycomb), plywood, etc. As appropriate for the particular mission packages(s) mounted, and/or the material comprising pallet 604, the pallet may be electrically grounded or electrically isolated.

Hence, pallet 604 is particularly well suited to hard-mount avionics boxes (606 through 610), and the like thereon, such as by bolting or screwing avionics cases, case flanges, mounting rails, or the like, to pallet 604 (see 104 and 208, above). Pallet 604 also has a plurality of orifices (i.e. through-holes) 612 sized, or otherwise adapted or configured, to accept aircraft industry standard readily releasable (i.e. rapidly releasable) anchor hardware 614, such as potted equipment track fittings described below with respect to FIG. 8.

Through the use of aircraft industry standard readily releasable anchor hardware 614, potted or otherwise disposed in the orifices or cavities 612, present pallets 604 are particularly well suited (i.e. adapted, or otherwise configured) for quick mounting to, and quick dismounting from, aircraft industry standard equipment tracks installed in the aircraft. (See 108 and 204, above.) To such an end, orifices or cavities 612 are each through-holes in pallet 604, extending generally perpendicular to face 618 (i.e. a mission equipment mounting surface) of pallet body 604, sized to accept and retain the aircraft industry standard readily releasable anchors, as best seen in FIG. 8.

With attention directed to FIG. 8, while referring back to FIGS. 6 and 7, readily releasable equipment track anchors 614 comprise a flange based stud 804 that defines a (threaded) shaft portion 806 receiving fastener (nut) 808, with retainer 810 secured by fastener(nut) 808 against and in track 602 to retain pallet 604 and hence avionics boxes 606 through 610, or the like, secured thereon, in place, along track 602. To this end, orifices (i.e. through-holes) 612 are also positioned to align with equipment track 602 installed in a predetermined (i.e. specified) arrangement in the aircraft. This maybe a predetermined or specified arrangement of the equipment track within the aircraft, which may, in accordance with some embodiments, be a generally standard spacing of such equipment track for mounting seats, or the like. In accordance with embodiments of the present systems and methods the aircraft industry standard readily releasable anchors may be potted into pallet body through-holes 612. In such embodiments, pots 620 may be disposed in pallet through-holes 612 and secured therein such as through adhesive bonding, with fasteners, or the like. To this end, pallet body through-hole orifices 612 extend generally perpendicular to mission equipment mounting surface 618 of pallet body 604, sized to accept and retain pots 620, which in turn accept and retain readily releasable anchors 614. Again, as best seen in FIG. 8, each pot 620 may comprise a generally cup-shaped body 812, with a top lip (i.e. flange) 814 adapted to rest (or bear) on face 618 (i.e. a mission equipment mounting surface) of pallet 604. An orifice (not shown) is defined in bottom 816 of pot cup 812 for passage of stud shaft 806. When fitting 614 is assembled in cup 620, nut 808 bears on bottom 816 of pot 620 and in-turn bottom 816 of cup 620 bears on top of retainer 810.

In accordance with alternative embodiments of the present systems and methods, mission package housings, such as, themselves, such as avionics boxes 606 through 610 (i.e. the avionics cases), may be modified in a manner similar to pallet 604 to employ aircraft industry standard readily releasable anchor hardware 614 to mount the case(s) directly to track/rails 602 for rapid reconfiguration, replacement, or the like.

In accordance with some embodiments of the present systems and methods the anchor hardware may comprise motorized components, which may be used to shift the aircraft's center of gravity (CG), in real time. Such embodiments may include a power supply for the motors mounted to panel 604 or a power supply provided by the aircraft. A power supply mounted to the panel might take the form of, or incorporate batteries, such as rechargeable batteries. Such batteries may be recharged through power provided by the aircraft or by ground services, between flights. Control may be provided via wireless connectivity to the motors or onboard wired connectivity to aircraft avionics.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A rapidly reconfigurable palletized mission equipment mounting method comprising:
installing a plurality of tracks or rails in an aircraft fuselage;
securing at least one mission package on a pallet outside the aircraft;
transferring the pallet with the at least one mission package secured thereto, into the aircraft; and
mounting the pallet in the aircraft on the tracks or rails, via readily releasable anchors positioned in the pallet to align with the tracks or rails installed in the aircraft, for rapidly dismounting from the tracks or rails.

2. The rapidly reconfigurable mission equipment mounting method of claim 1, wherein the tracks or rails are installed in or on a flat interior surface of a fuselage of the aircraft and the pallet is mounted via the readily releasable anchors to the interior surface, inside the aircraft.

3. The rapidly reconfigurable mission equipment mounting method of claim 1, wherein the tracks or rails are installed in or on a deck of a fuselage of the aircraft and the pallet is mounted via the readily releasable anchors to the deck, inside the aircraft.

4. The rapidly reconfigurable mission equipment mounting method of claim 1, wherein the pallet further comprises a pallet body that has a plurality of orifices accepting the readily releasable anchors, the orifices positioned to align with the tracks or rails installed in the aircraft.

5. The rapidly reconfigurable mission equipment mounting method of claim 1, wherein the one or more mission packages comprises at least one avionics package and the rapidly reconfigurable mission equipment mounting method further comprises connecting electrical harnesses of the aircraft to the at least one avionics package, following mounting of the pallet via the readily releasable anchors in the aircraft.

6. The rapidly reconfigurable mission equipment mounting method of claim 1, further comprising adjusting a center of gravity of the aircraft, wherein adjusting the center of gravity of the aircraft comprises:
loosening the readily releasable anchors;
moving the pallet along the rails, repositioning the aircraft center of gravity; and
resecuring the readily releasable anchors.

7. The rapidly reconfigurable mission equipment mounting method of claim 1, further comprising replacing the one or more mission packages with one or more replacement mission packages, wherein replacing the one or more mission packages with one or more replacement mission packages comprises:
dismounting one or more current mission packages from the pallet mounting the current mission packages;
removing dismounted current mission packages from the aircraft;
transferring one or more replacement mission packages into the aircraft; and
mounting the one or more replacement mission packages on the pallet, in the aircraft.

8. The rapidly reconfigurable mission equipment mounting method of claim 1, further comprising replacing the one or more mission packages with one or more replacement mission packages, wherein replacing the one or more mission packages with the one or more replacement mission packages comprises:
dismounting the pallet mounting current mission packages from the tracks or rails by releasing the readily releasable anchors;
removing the pallet mounting current mission packages from the aircraft;
transferring a pallet mounting the one or more replacement mission packages into the aircraft; and
mounting the pallet mounting the one or more replacement mission packages via the readily releasable anchors, in the aircraft on the tracks or rails, for rapid dismount from the tracks or rails.

9. A rapidly reconfigurable mission equipment mounting method comprising:
installing a plurality of tracks or rails in an aircraft fuselage;
mounting a pallet in the aircraft on the tracks or rails, via readily releasable anchors positioned in the pallet to align with the tracks or rails installed in the aircraft, for rapidly dismounting from the tracks or rails;
transferring one or more mission packages into the aircraft; and
securing the at least one mission packages on the pallet, inside the aircraft.

10. The rapidly reconfigurable mission equipment mounting method of claim 9, wherein the tracks or rails are installed in or on a flat interior surface of a fuselage of the aircraft and the pallet is mounted via the readily releasable anchors to the interior surface, inside the aircraft.

11. The rapidly reconfigurable mission equipment mounting method of claim 9, wherein the tracks or rails are installed in or on a deck of a fuselage of the aircraft and the pallet is mounted via the readily releasable anchors to the deck, inside the aircraft.

12. The rapidly reconfigurable mission equipment mounting method of claim 9, wherein the pallet further comprises a pallet body that has a plurality of orifices accepting the readily releasable anchors, the orifices positioned to align with the tracks or rails installed in the aircraft.

13. The rapidly reconfigurable mission equipment mounting method of claim 9, wherein the one or more mission packages comprises at least one avionics package and the rapidly reconfigurable mission equipment mounting method further comprises connecting electrical harnesses of the aircraft to the at least one avionics package, following mounting of at least one avionics package on the pallet in the aircraft.

14. The rapidly reconfigurable mission equipment mounting method of claim 9, further comprising adjusting a center of gravity of the aircraft, wherein adjusting the center of gravity of the aircraft comprises:
loosening the readily releasable anchors;
moving the pallet along the rails, repositioning the aircraft center of gravity; and
resecuring the readily releasable anchors.

15. The rapidly reconfigurable mission equipment mounting method of claim 9, further comprising replacing the one or more mission packages with one or more replacement mission packages, wherein replacing the one or more mission packages with one or more replacement mission packages comprises:
dismounting one or more current mission packages from the pallet mounting the current mission packages;
removing dismounted current mission packages from the aircraft;
transferring one or more replacement mission packages into the aircraft; and
mounting the one or more replacement mission packages on the pallet, in the aircraft.

16. The rapidly reconfigurable mission equipment mounting method of claim 9, further comprising replacing the one or more mission packages with one or more replacement mission packages, wherein replacing the one or more mission packages with the one or more replacement mission packages comprises:
dismounting the pallet mounting current mission packages from the tracks or rails by releasing the readily releasable anchors;
removing the pallet mounting current mission packages from the aircraft;
transferring a pallet mounting the one or more replacement mission packages into the aircraft; and
mounting the pallet mounting the one or more replacement mission packages via the readily releasable anchors, in the aircraft on the tracks or rails, for rapid dismount from the tracks or rails.

17. A rapidly reconfigurable palletized mission equipment mounting system comprising:
a plurality of tracks or rails installed in an aircraft fuselage;
a mission equipment mounting pallet, mounting at least one mission package, the mission equipment mounting pallet comprising a rapidly reconfigurable mission equipment mounting pallet body defining a plurality of orifices sized to accept releasable anchor hardware and positioned to align with the tracks or rails installed in the aircraft; and
readily releasable anchors disposed in the orifices and configured to rapidly mount to, and rapidly dismount from, the tracks or rails.

18. The rapidly reconfigurable mission equipment mounting system of claim 17, wherein the tracks or rails are installed in or on an interior flat surface of a fuselage of the aircraft.

19. The rapidly reconfigurable mission equipment mounting system of claim 17, wherein the tracks or rails are installed in or on a deck of a fuselage of the aircraft.

20. The rapidly reconfigurable mission equipment mounting system of claim 17, wherein the pallet body comprises a lightweight honeycomb core bonded panel.

21. The rapidly reconfigurable mission equipment mounting system of claim 17, wherein the orifices are each pallet through-holes that extend generally perpendicular to a mission equipment mounting surface of the pallet body, sized to accept and retain the readily releasable anchors.
